(19) United States
(12) Patent Application Publication
(10) Pub. No.: US 2023/0380382 A1
(43) Pub. Date: Nov. 30, 2023

(54) Pet communication and control system

(71) Applicant: Mary G. Stimson, Dallas, TX (US)

(72) Inventor: Mary G. Stimson, Dallas, TX (US)

(21) Appl. No.: 17/828,503

(22) Filed: May 31, 2022

(51) Int. Cl. A01K 15/02; A01K 29/00

(52) U.S. Cl. CPC A01K 15/021; A01K 29/005

(57) ABSTRACT

A system comprises a pet communication device, and a controller. The device comprises a circuit board supported in a housing. The circuit board has first and second non-overlapping bus elements configured in a grid. A point of overlap associated with first and second bus elements comprises a trigger point. An overlay is positioned atop the circuit board and includes a cutout corresponding to the overlap point. A button element is removably retained in the cutout above the overlap point. The button element comprises a depressible cover, and a physical structure underlying the depressible cover that configured to be brought into physical contact with the bus elements when depressed. The button element itself is electrically inert. The controller includes first code configured to provide an activation signal that activates the trigger point, and second code configured to track depression of the button element only following activation of the trigger point.

### BACKGROUND

### Technical Field

This disclosure relates generally to communication devices and systems that facilitate interactions with pets.

### Related Art

It is known in the prior art to provide a communication system and method to receive a notification from a pet that has been trained to interact with the system. A representative approach is described in U.S. Publication No. 2017/0372567. In this system, and as depicted in FIG. 1, a remote computer 16, which may be a smart phone or a tablet, has a notification application 12 loaded on a memory. A pet unit 10 has a press activator 20, a wireless transmitter 18, and a processor. The processor transmits a signal to the remote computer via the wireless transmitter when the push activator 20 is pushed by a pet 14. The signal activates the notification application to cause an alert to display on the remote computer. Similar types of pet training devices, systems and methods are described in U.S. Pat. No. 10,506,794, and U.S. Publication No. 2021/0337767.

While the above-described techniques provide advantages, there remains a need to provide enhanced systems and devices that facilitate pet interactions.

### BRIEF SUMMARY

A system comprises a pet communication device, and a controller. The device comprises a circuit board supported in a housing. The circuit board has first and second bus elements configured in a grid. The first and second elements are non-overlapping. A point of overlap associated with the first and second bus elements comprises a trigger point. An overlay is positioned atop the circuit board and includes a cutout corresponding to the overlap point. A button element is removably retained in the cutout above the overlap point. The button element comprises a depressible cover, and a physical structure underlying the depressible cover that configured to be brought into physical contact with the first and second bus elements (and thus the trigger point) when depressed. The button element itself is electrically inert. The controller includes first code configured to provide an activation signal that activates the trigger point, and second code configured to track depression of the button element only following activation of the trigger point.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a simplified depiction of a prior art pet communication device;

FIG. 2 is a block diagram of a system of this disclosure comprising a pet communication device, and a controller;

FIG. 3 depicts an exploded view of a triggering element in the pet communication device;

FIG. 4 depicts the depressible cover of the triggering element.

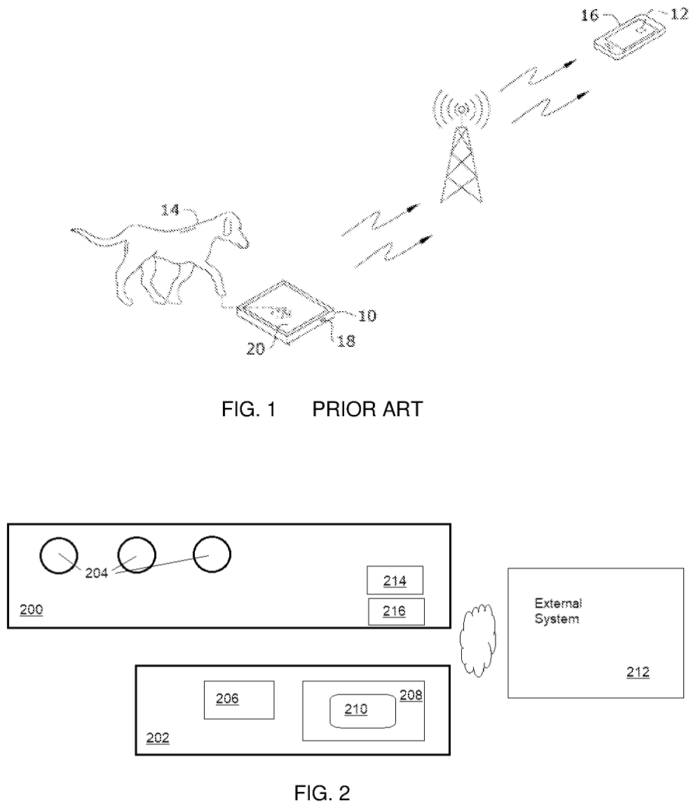

### DETAILED DESCRIPTION

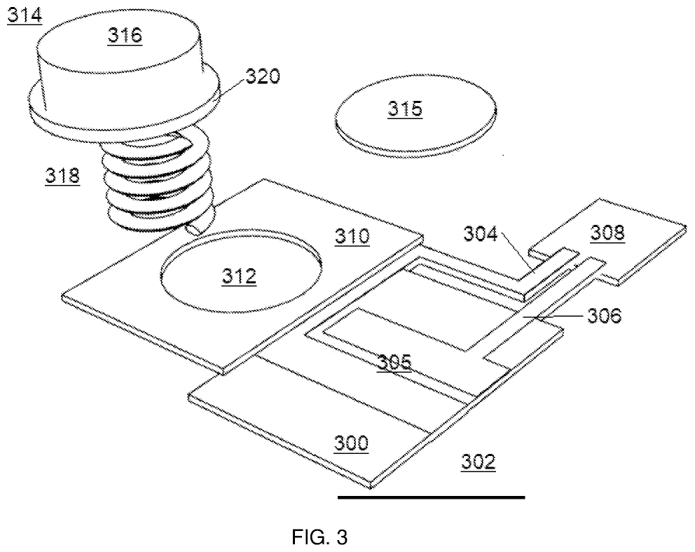

FIG. 2 depicts a pet communication and control system of this disclosure. The system comprises two primary components, a pet communication device 200, and a controller 202. The controller 202 is depicted as distinct from the pet communication device, which is the usual configuration, although it should be appreciated that processing components in the controller may be co-located with the device itself. Typically, the pet communication device and the controller are in communication with one another, e.g., over a wireless connection such as Wi-Fi, Bluetooth, Femto, other near field communication (NFC) protocols, or the like. In an alternative embodiment, these devices are connected via a wired connection (e.g., Ethernet). In still another embodiment, the controller is coupled to the pet communication device over a wide area network, such as the Internet. The controller may be configured as a dedicated device, or it may execute as an application executing on a computing device, such as a desktop, laptop, smart phone, tablet or other network-connected device. The pet communication device 200 is a physical device typically configured to be located on a floor or other support surface. The device 200 comprises one or more (and typically many) triggering elements 204 that are configured to be depressed by an animal trained to do so. As such, typically the device sits on a floor. When multiple triggering elements are used, the elements may be spaced from one another to prevent unintentional depression. A particular triggering element may have an operation that is distinct from another triggering element. As will be described, each triggering element is selectively configured to generate a signal when depressed by an animal, such as a dog. The signal generated by the triggering element, however, may or may not be output from the device, dependent on whether the triggering element itself has been “activated” or configured to do so by the controller 202. As noted, an animal is trained to depress the triggering element(s).

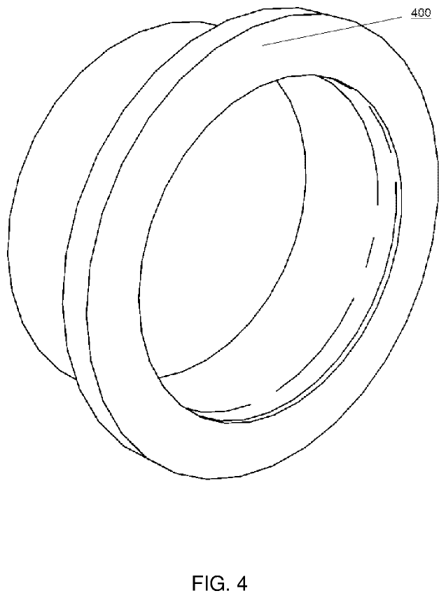

As depicted in FIG. 3, which is an exploded view of the triggering element, the pet communication device comprises several structural and electrical elements including a circuit board 300 supported in a housing 302. The housing may be made of a non-conducting material such as molded plastic, wood, or the like. The circuit board 300 has first and second bus (conductive) elements 304 and 306 configured in a grid. The first and second elements are non-overlapping, as depicted. A power source 308 (such as a battery, an AC-source, or the like) is connected to the grid. A point of overlap is associated with the first and second bus elements 304 and 306 and comprises a trigger point 305. An overlay 310 is positioned atop the circuit board 300 and includes a cutout 312 corresponding to the overlap point. A button element 314 is removably received and retained in the cutout above the overlap point. The button element comprises a depressible cover 316, a spring 318 (which may be made of plastic, a foam mesh, or the like), and a physical structure 320 underlying the depressible cover that is configured to be brought into physical contact with the first and second bus elements (and thus the trigger point) when depressed by the pet. In particular, the spring is 318 is positioned within the cutout 312 underlying the depressible cover 316 and atop the trigger point 305. Preferably, the button element itself (including the spring 318) includes no direct wiring and thus is electrically inert. In one embodiment, a metal washer or the like is positioned on the underside of the button as the physical structure 320 to close the circuit (created by the grid) when depressed. Stated another way, the depression of the depressible cover closes the electrical circuit located at the trigger point by bringing the metal washer into contact with the first and second bus elements, thereby selectively generating an output signal (from the pet communication device). In an alternative embodiment, as depicted in FIG. 4, the underside 400 of the depressible element itself is formed of metal or other conductive material such that depression of the button element (that includes such structure) closes the electrical circuit. Thus, in one embodiment the physical structure that enables the trigger point to be active is separate from the depressible cover, and in another embodiment the physical structure is integral with the cover. In still another embodiment, the depressible element does not include any conductive material, but the animal's paw is sufficiently conductive so as to close the electrical circuit.

Preferably, each of the triggering elements in the pet communication device have a similar physical and electrical structural configuration (namely, the conducting elements forming the grid, and the overlay with the cutout to receive the depressible element, etc.). As noted above, however, whether a particular depressible element is active preferably depends on whether the trigger point that underlies that element has been turned on (for control or data logging purposes).

With the above-described configuration, a particular position on the pet communication device corresponding to the trigger point may include the removable button element or, in the alternative, a cover 315, that fits within the cutout (and thus overlays the underlying circuit elements). In the latter case, the trigger point cannot be activated even if the animal places a paw on the location. This structural configuration, however, enables a user to easily remove the cover when desired and to then position the button element in the location. In this manner, the user can also selectively expand (or reduce) the number of active positions that are exposed to the animal in the pet communication device. This flexibility is facilitated by the structural configuration depicted in FIG. 2, and the use of the otherwise electrically-inert button elements. As will be described further, preferably there are two (2) requirements that are met before a particular location on the pet communication device becomes active: (1) the cover is removed and replaced by the button element, and (2) the trigger point itself is activated by the controller. As used herein, the notion of being activated by the controller means that the particular position on the pet communication device is capable of generating a control signal that is then used and/or recorded (logged) as such. This latter operation is now described.

Referring back to FIG. 2, the controller 202 includes a processor 206, computer memory 208, and program code 210. Program code 210 includes first program code configured to provide an activation signal that activates the trigger point, and second program code configured to track depression of the button element (at the location) only following activation of the trigger point. Typically, the activation signal is an internal flag that instructs a logging component (itself part of the program code) that the particular location is now active. In addition, program code 210 typically includes third program code configured to output the output signal, e.g., to interface to one or more external systems 212, such as a lighting system, a video communication system, and a network-connected messaging system. The nature and type of external system may vary depending on how the pet communication system is configured for use and interaction.

As also shown in FIG. 2, the pet communication device 200 typically also includes a light 214, and an audio source 216, associated with the button element. Other types of signaling components (e.g., haptic elements) may be used as well. The second program code is further configured by the processor 206 to activate the light 214 or audio source 216 in response to depression of the button element. In this manner, the pet is provided with a visual or audio confirmation when the button element (when otherwise activated) is depressed. In an alternative embodiment, the visual or audio signaling is provided in advance to act as visual/audio cue(s) designed to cause the pet to depress the element. For example, and in this alternative embodiment, the third program code is configured to receive a message from an external source (e.g., a network-connected social media account) and, in response, to control activation of the light or audio source. Thus, the visual or audio cues may originate from the external system.

As noted above, the device and the controller communicate with one another over a wireless or wired connection. Network communication elements (e.g., transmitter, receiver, or other data processing elements) are supported in the device and controller for this purpose. Communications between the device and controller may be over a secure connection, encrypted, or otherwise protected against discovery or spoofing. In one embodiment, the controller is a micro-controller (although this is not a limitation), and a separate mobile application (app) is used for interoperability with external systems (such as described above). The mobile app may also provide a user interface for data display (e.g., visualizations), and the like.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

Having described the subject matter, what I now claim is set forth below:

1. A pet communication and control system, comprising:
a pet communication device, comprising:
a circuit board supported in a housing, the circuit board comprising first and second bus elements that are configured in a grid, the first and second bus elements being arranged in a non-overlapping manner, wherein at least one point of overlap associated with the first and second bus elements comprises a trigger point;
a power source connected to the grid;
an overlay positioned atop the circuit board, wherein the overlay has a cutout corresponding to the at least one point of overlap;
a button element configured to be removably retained in the cutout above the at least one point of overlap, the button element comprising a depressible cover, and a physical structure underlying the depressible cover that is configured to be brought into physical contact with the first and second bus elements at the trigger point when depressed from a first position to a second position, wherein the button element is electrically inert; and
a controller comprising computer program code executable in a processor, the computer program code including first program code configured to provide an activation signal that activates the trigger point, and second program code configured to track depression of the button element only following activation of the trigger point.

2. The pet communication and control system as described in claim 1 wherein the pet communication device further includes a depressible spring positioned within the cutout underlying the cover and atop the trigger point.

3. The pet communication and control system as described in claim 2 wherein depression of the depressible cover closes a circuit located at the trigger point to generate an output signal.

4. The pet communication and control system as described in claim 1 wherein the pet communication device further includes third program code configured to output the output signal.

5. The pet communication and control system as described in claim 4 wherein the output signal is output to interface to one of: a lighting system, a video communication system, and a network-connected messaging service.

6. The pet communication and control system as described in claim 1 wherein the physical structure of the button element is formed of a conductive material.

7. The pet communication and control system as described in claim 6 wherein the physical structure is separate from the depressible cover or integral therewith.

8. The pet communication and control system as described in claim 1 wherein the pet communication device further includes a light or audio source associated with the button element.

9. The pet communication and control system as described in claim 8 wherein the second program code is further configured to activate the light or audio source in response to depression of the button element.

10. The pet communication and control system as described in claim 8 wherein the computer program code includes third program code configured to receive a message from an external source and, in response to activate the light or audio source.

11. The pet communication and control system as described in claim 10 wherein the external source is a network-connected social media account

12. The pet communication and control system as described in claim 1 wherein the overlay has an additional cutout configured to receive a second button element, the second button element having a depressible cover overlaying a second trigger point.

13. The pet communication and control system wherein the computer program code is a mobile application.

14. A communication device, comprising:
a circuit board supported in a housing, the circuit board comprising first and second bus elements that are configured in a grid, the first and second bus elements being arranged in a non-overlapping manner, wherein at least one point of overlap associated with the first and second bus elements comprises a trigger point;
a power source connected to the grid;
an overlay positioned atop the circuit board, wherein the overlay has a cutout corresponding to the at least one point of overlap; and
a button element configured to be removably retained in the cutout above the at least one point of overlap, the button element comprising a depressible cover, and a physical structure underlying the depressible cover that is configured to be brought into physical contact with the trigger point when depressed from a first position to a second position, wherein the button element is electrically inert.

15. The communication device as described in claim 14 further including includes a depressible spring positioned within the cutout underlying the cover and atop the trigger point.

16. The communication device as described in claim 14 further including a removable cover configured in the cutout.
